(19) United States
(12) Patent Application Publication
(10) Pub. No.: US 2026/0010994 A1
(43) Pub. Date: Jan. 8, 2026

(54) DYNAMIC BALANCE INSPECTION SYSTEM AND METHOD THEREOF

(71) Applicant: INDUSTRIAL TECHNOLOGY RESEARCH INSTITUTE, Hsinchu (TW)

(72) Inventors: Ming-Chun HO, Taichung City (TW); Chao-Chuang MAI, Taichung City (TW); Che-Wei HSU, Taichung City (TW)

(73) Assignee: INDUSTRIAL TECHNOLOGY RESEARCH INSTITUTE, Hsinchu (TW)

(21) Appl. No.: 18/964,270

(22) Filed: Nov. 29, 2024

(30) Foreign Application Priority Data
Jul. 8, 2024 (TW) 113125501

(51) Int. Cl. G06T 7/00; G01M 1/32; G06T 7/62; G06T 7/70

(52) U.S. Cl. CPC G06T 7/0002; G01M 1/32; G06T 7/62; G06T 7/70

(57) ABSTRACT

A dynamic balance inspection system includes a first image-capturing unit, an offset angle calculation unit, a dynamic balance test processing unit and a compensation calculation unit. The first image-capturing unit is disposed on a first side of a rotor and is movable along an axis to capture a first image of a positioning structure and a second image of a plurality of first counterweight portions. The offset angle calculation unit obtains a first orientation corresponding to the positioning structure according to the first image, a second orientation corresponding to a first designated counterweight portion of the first counterweight portions according to the second image, and a first angular difference between the first and second orientations. The dynamic balance test processing unit receives a first compensation angle and a first compensation mass. The compensation calculation unit generates a first actual compensation position and a first actual compensation mass.

This application claims the benefit of Taiwan application Serial No. 113125501, filed Jul. 8, 2024, the disclosure of which is incorporated by reference herein in its entirety.

### TECHNICAL FIELD

The disclosure relates to a dynamic balance inspection system and a method thereof.

### BACKGROUND

Generally speaking, dynamic balance inspection needs to be performed on some rotation devices (such as the fan and the rotor of a motor) by compensating an unbalanced amount, hence avoiding the device generating unstable wobbling during rotation which would otherwise cause damage or decrease output efficiency. During the installation of dynamic balance inspection, the efficiency of dynamic balance inspection cannot be increased because the unbalanced amount needs to be repeatedly compensated using the operators' experience.

### SUMMARY

The disclosure is directed to a dynamic balance inspection system and a method thereof.

According to one embodiment of the disclosure, a dynamic balance inspection system for performing dynamic balance inspection on a dynamic balancer with respect to a rotor of a motor is provided. The rotor includes a positioning structure and a plurality of first counterweight portions located on a first side of the rotor. The dynamic balance inspection system includes a first image-capturing unit, an offset angle calculation unit, a dynamic balance test processing unit and a compensation calculation unit. The first image-capturing unit is disposed on the first side of the rotor and is movable along an axis to capture a first image of the positioning structure located on a first terminal surface and a second image of the first counterweight portions located on a second terminal surface, wherein the first terminal surface and the second terminal surface are perpendicular to the axial direction and are spaced from each other in the axial direction. The offset angle calculation unit is electrically connected to the first image-capturing unit to obtain a first orientation corresponding to the positioning structure according to the first image, obtain a second orientation corresponding to a first designated counterweight portion of the first counterweight portions according to the second image, and obtain a first angular difference between the first orientation and the second orientation. The dynamic balance test processing unit is electrically connected to the dynamic balancer to receive a first compensation angle of the first side of the rotor and a first compensation mass corresponding to the first compensation angle from the dynamic balancer, wherein the first compensation angle is generated by using the positioning structure as a datum point of a dynamic balance polar coordinate system. The compensation calculation unit is electrically connected to the offset angle calculation unit and the dynamic balance test processing unit to generate at least one first actual compensation position and at least one first actual compensation mass corresponding to the at least one first actual compensation position according to the first angular difference, the first compensation angle and the first compensation mass.

According to another embodiment of the disclosure, a dynamic balance inspection method for performing dynamic balance inspection on a dynamic balancer with respect to a rotor of a motor is provided, wherein the rotor includes a positioning structure and a plurality of first counterweight portions located on a first side of the rotor. Firstly, a first image of the positioning structure located on a first terminal surface and a second image of the first counterweight portions located on a second terminal surface are captured by a first image-capturing unit, wherein the first image-capturing unit is disposed on the first side of the rotor and is movable along an axis, and the first terminal surface and the second terminal surface are perpendicular to the axial direction and are spaced from each other in the axial direction. Next, a first orientation corresponding to the positioning structure is obtained according to the first image, a second orientation corresponding to a first designated counterweight portion of the first counterweight portions is obtained according to the second image, and a first angular difference between the first orientation and the second orientation is obtained by an offset angle calculation unit. Then, a first compensation angle of the first side of the rotor and a first compensation mass corresponding to the first compensation angle are received from the dynamic balancer, wherein the first compensation angle is generated by using the positioning structure as a datum point of a dynamic balance polar coordinate system. After that, at least one first actual compensation position and at least one first actual compensation mass corresponding to the at least one first actual compensation position are generated by a compensation calculation unit according to the first angular difference, the first compensation angle and the first compensation mass.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram illustrating a rotor of a motor according to an embodiment of the present disclosure;

FIG. 2A shows a left-side view of the rotor of FIG. 1;

FIG. 2B shows a right-side view of the rotor of FIG. 1;

FIG. 3 shows a schematic diagram illustrating a dynamic balance inspection system according to an embodiment of the present disclosure;

FIG. 4 shows a schematic diagram illustrating a tool according to an embodiment of the present disclosure;

FIG. 5 shows a schematic diagram illustrating the tool of FIG. 4 being disposed on a shaft of a rotor;

FIG. 6 shows a block diagram illustrating a dynamic balance inspection system according to an embodiment of the present disclosure;

FIG. 7 shows a flowchart of a dynamic balance inspection method according to an embodiment of the present disclosure;

FIG. 8A shows a schematic diagram illustrating an embodiment of a first image;

FIG. 8B shows a schematic diagram illustrating an embodiment of a second image;

FIG. 9 shows a detailed flowchart of step S16 of FIG. 7;

FIG. 10 shows a detailed flowchart of step S18 of FIG. 7;

FIG. 11A shows a schematic diagram illustrating an embodiment of locating a first actual compensation position;

FIG. 11B shows a schematic diagram illustrating a first compensation suggested image according to the first actual compensation position located in FIG. 11A;

FIG. 12A shows a schematic diagram illustrating another embodiment of locating the first actual compensation position;

FIG. 12B shows a schematic diagram illustrating a first compensation suggested image according to the first actual compensation position located in FIG. 12A;

FIG. 13A shows a schematic diagram illustrating an alternate embodiment of locating the first actual compensation position; and

FIG. 13B shows a schematic diagram illustrating a first compensation suggested image according to the first actual compensation position located in FIG. 13A.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Detailed descriptions of each embodiment of the present invention are disclosed below with reference to accompanying drawings. Apart from the said detailed descriptions, any embodiments in which the present invention can be used as well as any substitutions, modifications or equivalent changes of the said embodiments are within the scope of the present invention, and the descriptions and definitions in the claims shall prevail. Specific details and embodiments are disclosed in the specification for anyone ordinary skilled in the art to comprehensively understand the present invention, not for limiting the present invention. Moreover, generally known procedures or elements are not disclosed to avoid adding unnecessary restrictions to the present invention.

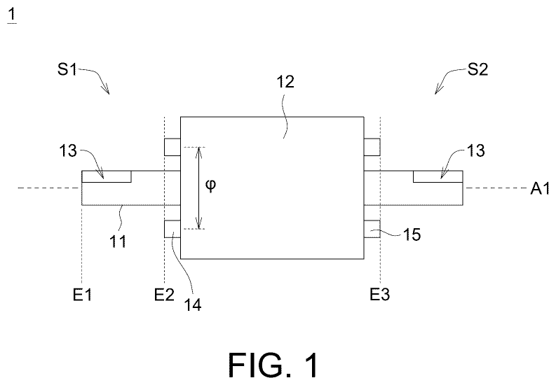

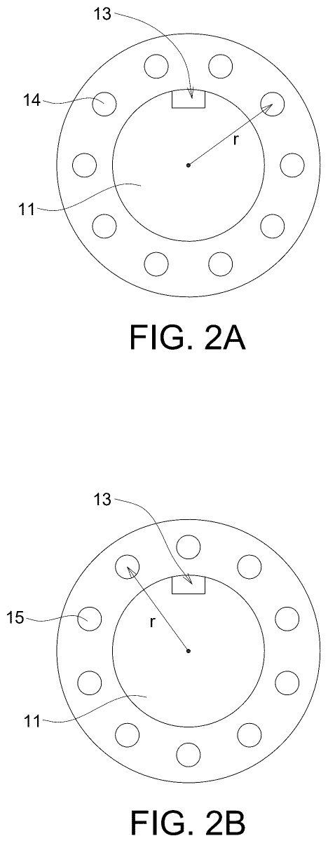

FIG. 1 shows a schematic diagram illustrating a rotor 1 of a motor according to an embodiment of the present disclosure. FIG. 2A shows a left-side view of the rotor 1 of FIG. 1. FIG. 2B shows a right-side view of the rotor 1 of FIG. 1.

Refer to FIG. 1, FIG. 2A and FIG. 2B. The rotor 1 has a first side S1 and a second side S2 opposite to the first side S1. The rotor 1 may include a shaft 11 and a body 12. The shaft 11 is disposed in an axial direction A1 and is rotatable along the axial direction A1. The shaft 11 can pass through the body 12. When the shaft 11 rotates, the shaft 11 can drive the body 12 to rotate together.

The rotor 1 may further include a positioning structure 13, a plurality of first counterweight portions 14 and a plurality of second counterweight portions 15. The positioning structure 13 can be located on the shaft 11. Two positioning structures 13 are respectively disposed on the first side S1 and the second side S2 of the rotor 1 and are opposite to each other. In a specific embodiment, the positioning structure 13 can be a keyseat. The first counterweight portions 14 can be disposed on the body 12, and are located on the first side S1 of the rotor 1. The second counterweight portions 15 can be disposed on the body 12 and are located on the second side S2 of the rotor 1. In a specific embodiment, the first counterweight portions 14 and the second counterweight portions 15 can be balance sprues.

As indicated in FIG. 2A and FIG. 2B, the first counterweight portions 14 and the second counterweight portions 15 can be arranged on the body 12 along the circumferential direction. The first counterweight portions 14 and the second counterweight portions 15 can be uniformly spaced along the circumferential direction and can have identical or different quantities. In an embodiment, if the first counterweight portions 14 and the second counterweight portions 15 have an identical quantity, such as 10, the angle formed by every two adjacent first counterweight portions 14 and the center of the shaft 11 is 36°, and the angle formed by every two adjacent second counterweight portions 15 and the center of the shaft 11 is also 36°.

The first counterweight portions 14 and the second counterweight portions 15 can be used to receive an actual compensation mass to compensate the unbalanced amount during dynamic balance inspection. In a specific embodiment, the actual compensation mass can be realized by a washer, but the disclosure is not limited thereto. As indicated in FIG. 2A and FIG. 2B, since the positions of the first counterweight portions 14 on the first side S1 of the rotor 1 may not correspond to the positions of the second counterweight portions 15 on the second side S2 of the rotor 1, dynamic balance inspection needs to be performed on the first side S1 and the second side S2 of the rotor 1 to compensate the unbalanced amount between the first side S1 and the second side S2.

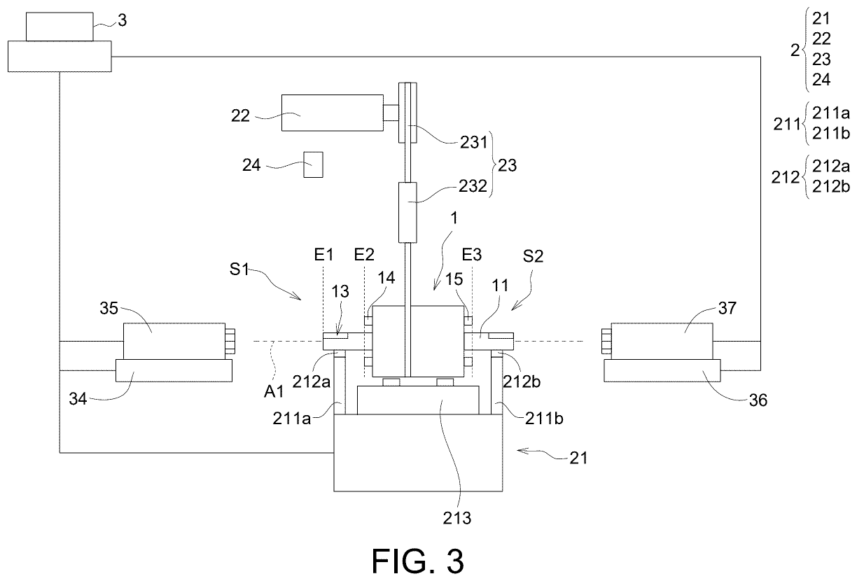

FIG. 3 shows a schematic diagram illustrating a dynamic balance inspection system 3 according to an embodiment of the present disclosure. The dynamic balance inspection system 3, such as a computer, cooperates with the dynamic balance testing mechanism 2 to perform dynamic balance inspection on the rotor 1. The dynamic balance testing mechanism 2 may include a dynamic balancer 21, an operation motor 22, a belt adjusting mechanism 23 and a position sensing unit 24. The rotor 1 can rotate on the dynamic balancer 21 along the axial direction A1. The dynamic balancer 21 may include a supporting structure 211, an unbalance sensor 212 and a carrier 213. The carrier 213 can be used to carry the rotor 1 and adjust the carrying height of the rotor 1. The supporting structure 211 may include a first supporting portion 211a and a second supporting portion 211b, respectively supporting the shaft 11 located on the first side S1 of the rotor 1 and the shaft 11 located on the second side S2 of the rotor 1. The unbalance sensor 212, such as an accelerator, may include a first sensing portion 212a and a second sensing portion 212b, respectively disposed on the first supporting portion 211a and the second supporting portion 211b. When the rotor 1 rotates on the dynamic balancer 21, the first sensing portion 212a and the second sensing portion 212b respectively measure the first sensing information of the shaft 11 located on the first side S1 of the rotor 1 and the second sensing information of the shaft 11 located on the second side S2 of the rotor 1.

The belt adjusting mechanism 23 may include a belt 231 and a force adjusting portion 232. The belt 231 can be connected to the operation motor 22 and the rotor 1. The force adjusting portion 232 can be used to adjust the torque of the belt 231. When the operation motor 22 is activated, the belt adjusting mechanism 23 can drive the rotor 1 to rotate on the dynamic balancer 21.

The position sensing unit 24, such as a laser light sensor, can detect the rotation speed of the rotor 1 by sensing the position of the positioning structure 13.

In an embodiment, if the positioning structure 13 is formed by a keyseat, which may cause unstable rotation to the rotor 1 when the rotor 1 rotates on the dynamic balancer 2. Under such circumstances, unstable rotation can be avoided through the use of a tool.

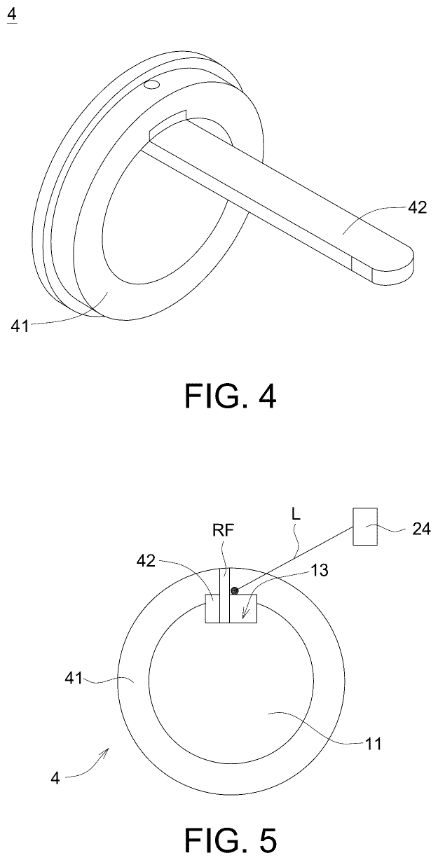

FIG. 4 shows a schematic diagram illustrating a tool 4 according to an embodiment of the present disclosure. Refer to FIG. 3 and FIG. 4. The tool 4 may include a ring portion 41 and a suspension arm 42. The ring portion 41 can be mounted on the shaft 11 of the rotor 1. The suspension arm 42 can be interposed to the positioning structure 13 on the shaft 11 to avoid unstable rotation of the rotor 1.

FIG. 5 shows a schematic diagram illustrating the tool 4 of FIG. 4 being disposed on a shaft 11 of a rotor 1. Refer to FIG. 5. The suspension arm 42 of the tool 4 can have a reflector RF disposed thereon. The light L emitted from the position sensing unit 24 can radiate on the reflector RF, so that the position of the positioning structure 13 can be detected.

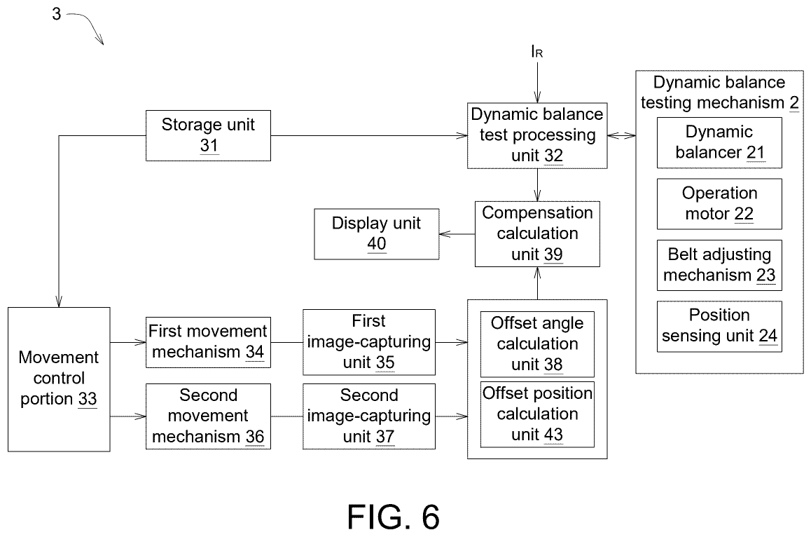

FIG. 6 shows a block diagram illustrating a dynamic balance inspection system 3 according to an embodiment of the present disclosure. Refer to FIG. 3 and FIG. 6. The dynamic balance inspection system 3 may include a storage unit 31, a dynamic balance test processing unit 32, a movement control portion 33, a first movement mechanism 34, a first image-capturing unit 35, a second movement mechanism 36, a second image-capturing unit 37, an offset angle calculation unit 38, an offset position calculation unit 43 and a compensation calculation unit 39. The dynamic balance test processing unit 32 can be electrically connected to the dynamic balance testing mechanism 2, the storage unit 31 and the compensation calculation unit 39; the movement control portion 33 can be electrically connected to the storage unit 31, the first movement mechanism 34 and the second movement mechanism 36; the offset angle calculation unit 38 and the offset position calculation unit 43 can be electrically connected to the first image-capturing unit 35, the second image-capturing unit 37 and the compensation calculation unit 39.

To be specifically, the storage unit 31 may be a hard drive (such as a mechanical hard drive or a solid-state drive), a memory, other storage devices or a combination thereof. The dynamic balance test processing unit 32, the movement control portion 33, the offset angle calculation unit 38, the offset position calculation unit 43, and the compensation calculation unit 39 may be software, hardware or firmware. In the case of hardware, the hardware can be realized by a processing unit, a processor, a computer or a server with data processing and calculating functions. In the case of software or firmware, the software or firmware may further include instructions that can be executed on a processing unit, a processor, a computer or a server and can be installed on the same hardware device or can be distributed over several different hardware devices. The first image-capturing unit 35 and the second image-capturing unit 37 may be a device with image capturing function, such as a camera, a video camera or a monitor.

The storage unit 31 can store a plurality of adjustment information corresponding to different rotors 1. Different rotors 1 can have different dimensions and different weights, and also can include the first counterweight portions 14 and/or the second counterweight portions 15 of different dimensions. Also refer to FIG. 1, FIG. 2A and FIG. 2B. Different rotors 1 can have different compensation outer diameters φ or different compensation radii r, wherein the compensation radius r can be defined as the distance from the center of the shaft 11 to the center of the first counterweight portions 14 or the center of the second counterweight portions 15; the compensation outer diameter φ can be defined as 2 times of the radius r. Continue to refer to FIG. 3 and FIG. 6. Since different rotors 1 may have different dimensions and different weights, and the first counterweight portions 14 and/or the second counterweight portions 15 may have different dimensions, there is a need to set a plurality of adjustment information to the different rotors 1. The adjustment information include but are not limited to at least one of the span and level of the supporting structure 211 of the dynamic balancer 21 and the height of the carrier 213 carrying the rotor 1, the torque of the belt adjusting mechanism 23, and the shooting positions of the first movement mechanism 34 and the second movement mechanism 36.

The first image-capturing unit 35 is disposed on the first side S1 of the rotor 1 and performs shooting in a direction towards the rotor 1. The second image-capturing unit 37 is disposed on the second side S2 of the rotor 1 and performs shooting in a direction towards the rotor 1. The first image-capturing unit 35 and the second image-capturing unit 37 can respectively be disposed on the first movement mechanism 34 and the second movement mechanism 36 and are movable along the axial direction A1 through the use of the first movement mechanism 34 and the second movement mechanism 36. Specifically, the first movement mechanism 34 and the second movement mechanism 36 respectively may include a driver, a screw, a slide rail, or a mobile platform. The driver can be controlled by the movement control portion 33. When the driver operates, it can drive the screw to rotate. The slide rail can be connected to the screw and can convert the rotation movement of the screw to a linear movement. The mobile platform can be disposed on the slide rail and can move linearly along with the slide rail. The first image-capturing unit 35 and the second image-capturing unit 37 can respectively be disposed on the mobile platform, therefore the first image-capturing unit 35 and the second image-capturing unit 37 can move in the axial direction A1 through the mobile platform which moves linearly.

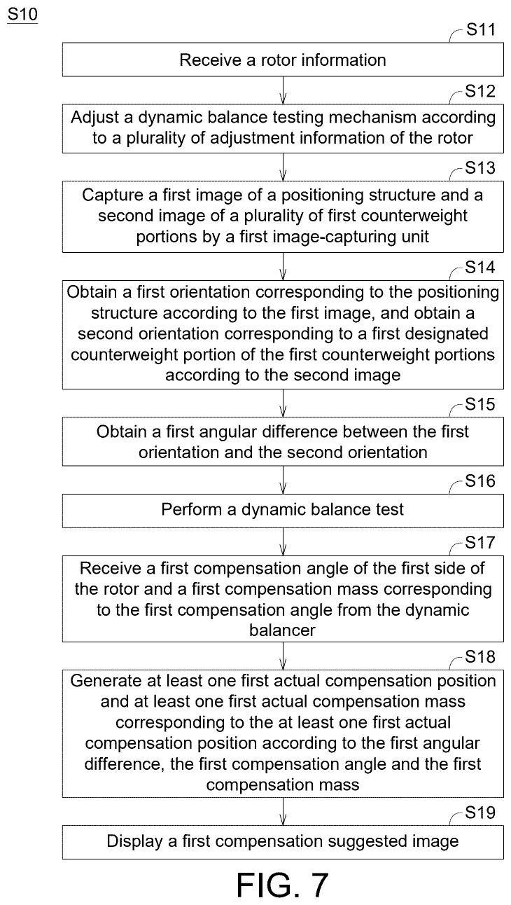

FIG. 7 shows a flowchart of a dynamic balance inspection method S10 according to an embodiment of the present disclosure. Refer to FIG. 3, FIG. 6 and FIG. 7. In step S11, a rotor information I_{R} is received by a dynamic balance test processing unit 32, the rotor information I_{R} may contain information, such as the dimension and weight of the rotor 1 and the dimension of the first counterweight portions 14 and/or the second counterweight portions 15 as well as the corresponding compensation outer diameter φ or compensation radius r of the rotor 1.

In step S12, a plurality of adjustment information corresponding to the same rotor 1 are selected from the storage unit 31 by the dynamic balance test processing unit 32 according to the rotor information I_{R}, and the dynamic balance testing mechanism 2 is adjusted according to the adjustment information. For instance, at least one of the span and level of the supporting structure 211 of the dynamic balancer 21, the height of the carrier 213 carrying the rotor 1, and the torque of the belt adjusting mechanism 23 is adjusted by the dynamic balance test processing unit 32.

In step S13, the first image of the positioning structure 13 and the second image of the first counterweight portions 14 are captured by the first image-capturing unit 35. Here, the positioning structure 13 and the first counterweight portions 14 are respectively located on different terminal surfaces perpendicular to the axial direction A1. That is, the positioning structure 13 is located on the first terminal surface E1 closer to the first image-capturing unit 35, and the first counterweight portions 14 is located on the second terminal surface E2 farther away from the first image-capturing unit 35. If the focal length of the lens of the first image-capturing unit 35 is fixed and cannot be adjusted, the shooting position at which the positioning structure 13 of the first terminal surface E1 and the first counterweight portions 14 of the second terminal surface E2 are shot in the axial direction A1 must be accurate set, so that the first image of the positioning structure 13 and the second image of the first counterweight portions 14 can be clearly shot and used for subsequent image recognition. Here, the movement control portion 33 can select adjustment information corresponding to the same rotor 1 from the storage unit 31. The adjustment information contains the shooting position, at which the first image-capturing unit 35 shoots the first terminal surface E1 and the second terminal surface E2. Then, the movement control portion 33 controls the first movement mechanism 34 according to the corresponding shooting position of the first image-capturing unit 35 and makes the first image-capturing unit 35 moved to the corresponding shooting position in the axial direction A1.

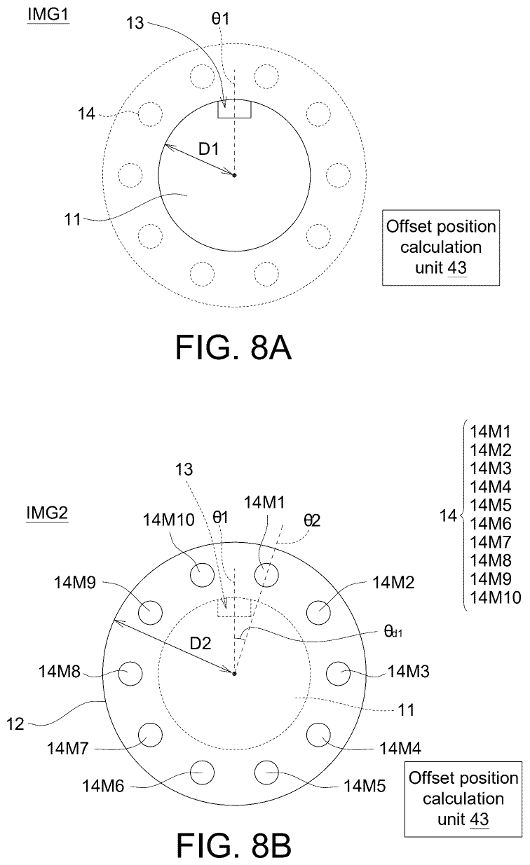

FIG. 8A shows a schematic diagram illustrating an embodiment of a first image IMG1. FIG. 8B shows a schematic diagram illustrating an embodiment of a second image IMG2. FIG. 8B shows ten first counterweight portions 14, namely, first counterweight portions 14M1 to 14M10, and the angle between every two adjacent counterweight portions and the center of the shaft 11 is 36°.

Refer to FIG. 3 and FIG. 8A. When the first image-capturing unit 35 moves to the shooting position corresponding to the first terminal surface E1 in the axial direction A1, the first image IMG1 of the positioning structure 13 can be clearly shot, but the image of the first counterweight portions 14 located on the second terminal surface E2 (represented by dotted lines) will be blurred or distorted due to an unmatched focal length.

Refer to FIG. 3 and FIG. 8B. When the first image-capturing unit 35 moves to the shooting position corresponding to the second terminal surface E2 in the axial direction A1, the second image IMG2 of the first counterweight portions 14 can be clearly shot, but the image of the positioning structure 13 located on the first terminal surface E1 (represented by dotted lines) will be blurred or distorted due to an unmatched focal length.

After obtaining the first image IMG1 and the second image IMG2, the offset angle calculation unit 38 can obtain the first image IMG1 and the second image IMG2 from the first image-capturing unit 35 and perform image recognition on the first image IMG1 and the second image IMG2. Also, refer to FIGS. 8A and 8B. In another embodiment, the dynamic balance inspection system 3 can further be equipped with dimension/position detection function. The detection method is as follows. The first image-capturing unit 35 shoots the first image IMG1 of the first terminal surface E1 and the second image IMG2 of the first terminal surface E2; the offset position calculation unit 43 calculates the inner circle diameter D1 and center position pf the shaft 11 according to the first image, and calculates the outer circle diameter D2 and center position of the body 12 according to the second image to determine whether the shaft 11 and the body 12 are located at normal positions. If it is determined that the dimensions or center positions of the shaft 11 and the body 12 are abnormal, position abnormality warning of the shaft 11 and the body 12 is announced. The operations of the offset position calculation unit 43 can be selectively integrated with the operations of the offset angle calculation unit 38. For instance, firstly, position offset is determined and eliminated; then, angle offset is calculated (such as the calculation of the first angular difference). The present disclosure does not have specific restrictions in this regard.

Refer to FIG. 3, FIG. 6, FIG. 7, FIG. 8A and FIG. 8B. In step S14, a first orientation θ1 corresponding to the positioning structure 13 is obtained by the offset angle calculation unit 38 according to the first image IMG1, wherein the first orientation θ1 can be represented by an angle, such as an angle relative to an original point (the vertical upward direction is set to 0°). Moreover, a second orientation θ2 corresponding to a first designated counterweight portion of the first counterweight portions 14 (such as the first counterweight portion 14M1) is obtained by the offset angle calculation unit 38 according to the second image IMG2. The second orientation θ2 can be represented by an angle, such as an angle relative to an original point. Since the first counterweight portions 14 can be uniformly spaced along the circumferential direction and the position of each of the first counterweight portions 14 is known, one of the first counterweight portions 14 can be selected as the first designated counterweight portion. For instance, the first counterweight portion 14M2 or the first counterweight portion 14M10 can be selected as the first designated counterweight portion.

In step S15, a first angular difference θ_{d1} between the first orientation θ1 and the second orientation θ2 is obtained by the offset angle calculation unit 38.

Then, the method proceeds to step S16, a dynamic balance test is performed by the dynamic balance test processing unit 32.

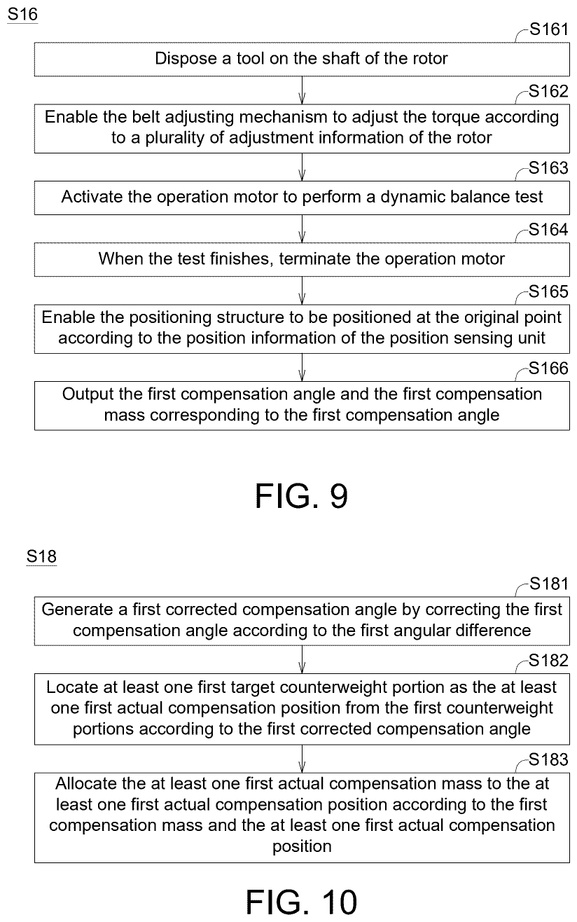

FIG. 9 shows a detailed flowchart of step S16 of FIG. 7. Refer to FIG. 3 to FIG. 7 and FIG. 9. In step S161, the tool 4 is disposed on the shaft 11 of the rotor 1.

In step S162, the belt adjusting mechanism 23 is enabled to adjust the torque by the dynamic balance test processing unit 32 according to the adjustment information selected in step S12.

In step S163, the operation motor 22 is activated by the dynamic balance test processing unit 32 to perform a dynamic balance test. Here, the dynamic balancer 21 can perform the dynamic balance test according to a settings file, which can be provided by the dynamic balance test processing unit 32. The settings file contains information obtained from the storage unit 31, such as the information corresponding to the compensation outer diameter q or compensation radius r of the rotor 1.

In step S164, when the test finishes, the operation motor 22 is terminated by the dynamic balance test processing unit 32.

Then, the method proceeds to step S165, the positioning structure 13 of the rotor 1 is positioned at the original point by the dynamic balance test processing unit 32 according to the position information of the position sensing unit 24 (as indicated in FIG. 8A, the vertical upward direction of the position of the original point is set to) 0°. For instance, a light L emitted by the position sensing unit 24 radiates on the position of the original point. When the light L radiates on the reflector RF, this indicates that the positioning structure 13 of the rotor 1 is located at the position of the original point. Thus, the dynamic balance test processing unit 32 can enable the operation motor 22 to rotate according to the position information, so that the positioning structure 13 of the rotor 1 can be positioned in the vertical direction as indicated in FIG. 8A.

In step S166, after the positioning structure 13 of the rotor 1 is positioned at the original point, the first compensation angle and the first compensation mass corresponding to the first compensation angle are outputted by the dynamic balancer 21. Here, based on the rotation speed of the rotor 1 and the corresponding compensation outer diameter φ or compensation radius r of the rotor 1, which are already known, the dynamic balancer 21 can calculate a first compensation angle and a first compensation mass corresponding to the first compensation angle according to the first sensing information of the first sensing portion 212a.

Refer to FIG. 3, FIG. 6 and FIG. 7. In step S17, the first compensation angle and the first compensation mass corresponding to the first compensation angle are received from the dynamic balancer 21 by the dynamic balance test processing unit 32.

Then, the method proceeds to step S18, at least one first actual compensation position and at least one first actual compensation mass corresponding to the at least one first actual compensation position are generated by the compensation calculation unit 39 according to the first angular difference (obtained in step S15), the first compensation angle and the first compensation mass (obtained in step S17).

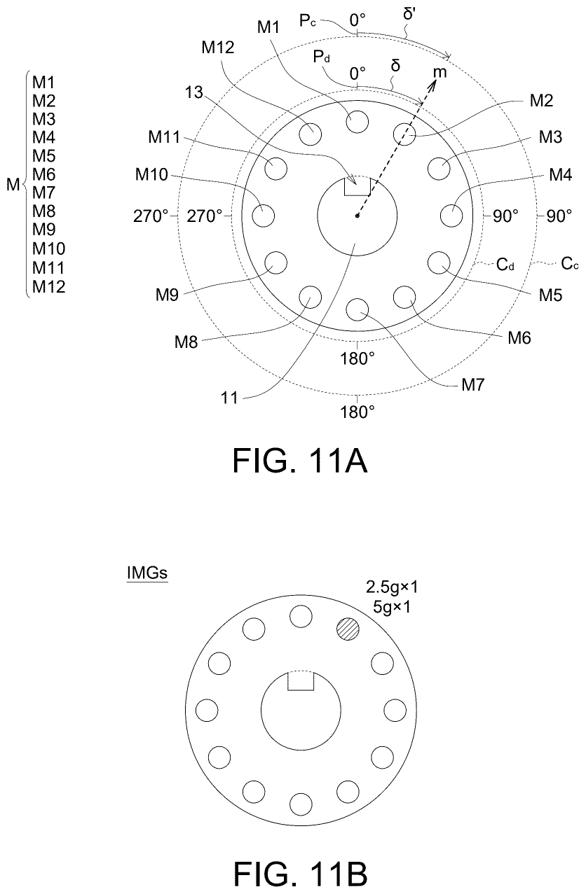

FIG. 10 shows a detailed flowchart of step S18 of FIG. 7. FIG. 11A shows a schematic diagram illustrating an embodiment of locating a first actual compensation position. In the embodiment of FIG. 11A, twelve first counterweight portions M, namely first counterweight portions M1˜M12, are illustrated, and the angle formed by every two adjacent first counterweight portions and the center of the shaft 11 is 30°.

Refer to FIG. 3, FIG. 6, FIG. 7, FIG. 10 and FIG. 11A. In step S181, a first corrected compensation angle δ′ is generated by correcting a first compensation angle δ by the compensation calculation unit 39 according to the first angular difference (obtained in step S15).

Refer to FIG. 3, FIG. 6, FIG. 9 and FIG. 11A. As indicated in step S166, the first compensation angle δ is outputted from the dynamic balancer 21. In step S165 prior to step S166, since the positioning structure 13 of the rotor 1 is already positioned at the position of the original point, the first compensation angle δ is generated by using the positioning structure 13 as a datum point P_{d} of a dynamic balance polar coordinate system C_{d}. That is, the first compensation angle δ is an angle relative to the zero angle of the dynamic balance polar coordinate system C_{d} (that is, relative to the position of the original point).

In the embodiment of FIG. 11A, the first counterweight portion M1 of the first counterweight portions M is selected and used as the first designated counterweight portion by the offset angle calculation unit 38. Since the first counterweight portion M1 exactly corresponds to the zero angle of the dynamic balance polar coordinate system C_{d} (that is, the position of the original point), the first angular difference is zero. Thus, the first corrected compensation angle δ′ generated by the compensation calculation unit 39 is equivalent to the first compensation angle δ. The first corrected compensation angle δ′ is generated by using the first designated counterweight portion (that is, the first counterweight portion M1) as the datum point P_{c} of a first compensation polar coordinate system C_{c} (that is, the zero angle of the first compensation polar coordinate system C_{c}).

Refer to FIG. 3, FIG. 6, FIG. 7, FIG. 10 and FIG. 11A. In step S182, at least one first target counterweight portion is located as at least one first actual compensation position from the first counterweight portions M by the compensation calculation unit 39 according to the first corrected compensation angle δ′.

Here, the compensation calculation unit 39 can select at least one portion closest to the first corrected compensation angle δ′ as at least one first target counterweight portion from a plurality of first counterweight portions M, so that the at least one first target counterweight portion can be used as at least one first actual compensation position. For instance, in the embodiment of FIG. 11A, the first compensation angle δ received from the dynamic balancer 21 is 30°. Since the first corrected compensation angle δ′ is equivalent to the first compensation angle δ, that is, the first corrected compensation angle δ′ is also equivalent to 30°, the compensation calculation unit 39, by using the datum point P_{c} of the first compensation polar coordinate system C_{c} as a starting point, starts to locate at least one portion closest to 30° as at least one first target counterweight portion from the first counterweight portions M. Here, the portion closest to 30° among the first counterweight portions M is the first counterweight portion M2, therefore the compensation calculation unit 39 uses the first counterweight portion M2 as the first target counterweight portion and uses the first target counterweight portion as the first actual compensation position.

Refer to FIG. 3, FIG. 6, FIG. 7, FIG. 10 and FIG. 11A. In step S183, at least one first actual compensation mass is allocated to at least one first actual compensation position by the compensation calculation unit 39 according to the first compensation mass m and at least one first actual compensation position.

Generally speaking, the first actual compensation mass has a fixed mass, which is not exactly equivalent to the weight of the first compensation mass m, therefore the first actual compensation mass needs to be allocated to the first actual compensation position in a suitable way. In an embodiment, the compensation calculation unit 39 locates at least one first actual compensation position then allocates the at least one first actual compensation mass to at least one first actual compensation position by means of optimization to minimize the compensated residual error.

For instance, in the embodiment of FIG. 11A, the first compensation mass m received from the dynamic balancer 21 is 8 grams, but the first actual compensation masses (such as the mass of the washer) are 2.5 g and 5 g. Then, the compensation calculation unit 39 respectively allocates the 2.5 g and 5 g first actual compensation masses to the position of the first counterweight portion M2 according to a first compensation mass m (8 g) and a first actual compensation position (i.e., the position of the first counterweight portion M2). Thus, the compensated residual error (D_{R}) can be calculated according to the following formula. The residual error is the minimized result obtained through the calculation of the compensation calculation unit 39.

$${D}_{R} = 8 - 7.5 = 0.5 ( g )$$

It should be understood that in other embodiments, the compensation calculation unit 39 also can locate at least one first actual compensation position then allocate the at least one first actual compensation mass to at least one first actual compensation position by means of a non-optimization method. For instance, the compensation calculation unit 39 can locate at least one first actual compensation position then allocate the at least one first actual compensation mass to at least one first actual compensation position as long as the residual error is less than the first actual compensation mass.

Refer to FIG. 6. In an embodiment, the dynamic balance inspection system 3 may further include a display unit 40. The display unit 40 can be electrically connected to the compensation calculation unit 39, such as an LCD display, an OLED display, an e-paper display or other types of displays.

Refer to FIG. 6 and FIG. 7. In step S19, a first compensation suggested image can be displayed by the display unit 40.

FIG. 11B shows a schematic diagram illustrating a first compensation suggested image IMGs according to the first actual compensation position as located in FIG. 11A. Refer to FIG. 6, FIG. 7, FIG. 11A and FIG. 11B. After the compensation calculation unit 39 generates at least one first actual compensation position and at least one first actual compensation mass corresponding to the at least one first actual compensation position (step S18), the display unit 40 can display the first compensation suggested image IMGs, the first compensation suggested image IMGs is displayed by marking the at least one first actual compensation position (the position of the first counterweight portion M2) and the at least one first actual compensation mass (2.5 g and 5 g) on the first side image corresponding to the first side S1 of the rotor 1. Thus, by viewing the first compensation suggested image IMGs displayed by the display unit 40, the operator can compensate the unbalanced amount on the first side S1 of the rotor 1.

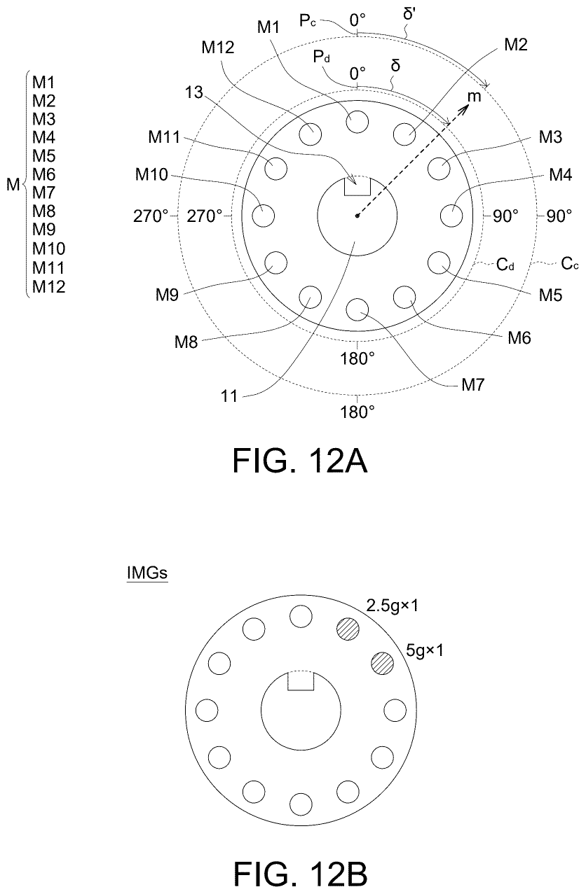

FIG. 12A shows a schematic diagram illustrating another embodiment of locating the first actual compensation position. FIG. 12B shows a schematic diagram illustrating a first compensation suggested image IMGs according to the first actual compensation position located in FIG. 12A. In the embodiment of FIG. 12A, twelve first counterweight portions M, namely first counterweight portions M1 to M12, are illustrated, and the angle formed by every two adjacent first counterweight portions and the center of the shaft 11 is 30°.

Refer to FIG. 6, FIG. 12A and FIG. 12B. In the present embodiment, the first angular difference is also equivalent to zero, the first compensation angle δ received from the dynamic balancer 21 is 45°, and the weight of the first compensation mass m is 8 grams (g).

Firstly, the compensation calculation unit 39 generates a first corrected compensation angle δ′ according to the first angular difference. Since the first angular difference is zero, the first corrected compensation angle δ′ is equivalent to the first compensation angle δ, that is, the first corrected compensation angle δ′ is also equivalent to 45°.

Then, the compensation calculation unit 39, by using the datum point P_{c} of a first compensation polar coordinate system C_{c} as a starting point, starts to locate at least one portion closest to 45° as at least one first target counterweight portion from a plurality of first counterweight portions M. Here, the portions closest to 45° among the first counterweight portions M respectively are the first counterweight portion M2 and the first counterweight portion M3, so the compensation calculation unit 39 uses the first counterweight portion M2 and the first counterweight portion M3 as the first target counterweight portions and uses the first target counterweight portions as the first actual compensation position.

Then, the compensation calculation unit 39 respectively allocates the first actual compensation masses (e.g., 2.5 g and 5 g) to the first counterweight portion M2 and the first counterweight portion M3 according to the first compensation mass m (8 g) and the first actual compensation position (the positions of the first counterweight portion M2 and the first counterweight portion M3). In another embodiment, the first actual compensation masses (e.g., 5 g and 2.5 g) respectively can be allocated to the positions of the first counterweight portion M2 and the first counterweight portion M3. Thus, the compensated residual error (D_{R}) can be calculated according to the following formula. The residual error is the minimized result obtained through the calculation of the compensation calculation unit 39.

$${D}_{R} = \sqrt{{( 8 sin 45 ° - 2.5 sin 30 ° - 5 sin 60 ° )}^{2} + {( 8 cos 45 ° - 2.5 cos 30 ° - 5 cos 60 ° )}^{2}} = 0.99475 ( g )$$

The display unit 40 can display the first compensation suggested image IMGs, wherein the first compensation suggested image IMGs is displayed by marking the at least one first actual compensation position (the positions of the first counterweight portion M2 and the first counterweight portion M3) and the at least one first actual compensation mass (2.5 g are allocated to the first counterweight portion M2, and 5 g are allocated to the first counterweight portion M3) on the first side image corresponding to the first side S1 of the rotor 1. Thus, by viewing the first compensation suggested image IMGs displayed by the display unit 40, the operator can compensate the unbalanced amount on the first side S1 of the rotor 1.

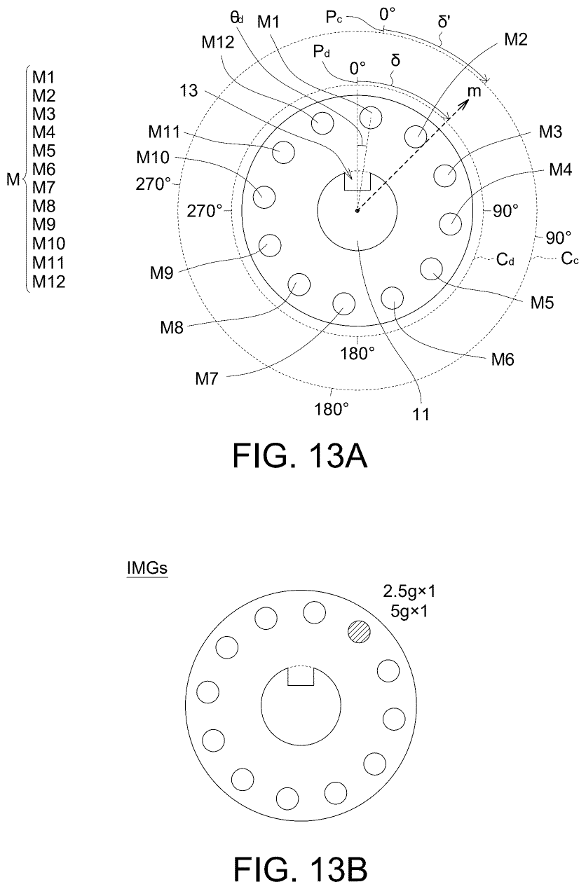

FIG. 13A shows a schematic diagram illustrating an alternate embodiment of locating the first actual compensation position. FIG. 13B shows a schematic diagram illustrating a first compensation suggested image IMGs according to the first actual compensation position located in FIG. 13A. In the embodiment of FIG. 13A, twelve first counterweight portions M, namely first counterweight portions M1 to M12, are illustrated and the angle formed by every two adjacent first counterweight portions and the center of the shaft 11 is 30°.

Refer to FIG. 6, FIG. 13A and FIG. 13B. In the present embodiment, the first angular difference θ_{d} is 12°, the first compensation angle δ received from the dynamic balancer 21 is 45°, and the weight of the first compensation mass m is 8 grams.

Firstly, the compensation calculation unit 39 generates a first corrected compensation angle δ′ according to the first angular difference θ_{d}. Since the first angular difference θ_{d} is 12°, the first corrected compensation angle δ′ is 33°.

Then, the compensation calculation unit 39, by using the datum point P_{c} of a first compensation polar coordinate system C_{c} as a starting point, starts to locate at least one portion closest to 33° as at least one first target counterweight portion from a plurality of first counterweight portions M. Here, the portion closest to 33° among the first counterweight portions M is the first counterweight portion M2, therefore the compensation calculation unit 39 uses the first counterweight portion M2 as the first target counterweight portion and uses the first target counterweight portion as the first actual compensation position.

Then, the compensation calculation unit 39 respectively allocates the first actual compensation masses (e.g., 2.5 g and 5 g) to the positions of the first counterweight portion M2 according to the first compensation mass m (8 g) and the first actual compensation position (the position of the first counterweight portion M2). Thus, the compensated residual error (D_{R}) can be calculated according to the following formula. The residual error is the minimized result obtained through the calculation of the compensation calculation unit 39

$${D}_{R} = \sqrt{{( 8 sin 33 ° - 7.5 sin 30 ° )}^{2} + {( 8 cos 33 ° - 7.5 cos 30 ° )}^{2}} = 0.64378 ( g )$$

The display unit 40 can display the first compensation suggested image IMGs, the first compensation suggested image IMGs is displayed by marking the at least one first actual compensation position (the position of the first counterweight portion M2) and the at least one first actual compensation mass (e.g., 2.5 g and 5 g) on the first side image corresponding to the first side S1 of the rotor 1. Thus, by viewing the first compensation suggested image IMGs displayed by the display unit 40, the operator can compensate the unbalanced amount on the first side S1 of the rotor 1.

In FIG. 11A, FIG. 11B, FIG. 12A, FIG. 12B, FIG. 13A and FIG. 13B, a plurality of first counterweight portions 14 on the first side S1 of the rotor 1 as indicated in FIG. 2A are represented by a plurality of first counterweight portions M, and how the first actual compensation position and the first actual compensation mass are generated in step S18 and how the first compensation suggested image IMGs is displayed in step S19 are exemplified. However, it should be understood that dynamic balance inspection should also be performed on the second side S2 of the rotor 1 to compensate the unbalanced amount of the second side S2. Thus, similar methods illustrated in FIG. 11A, FIG. 11B, FIG. 12A, FIG. 12B, FIG. 13A and FIG. 13B are also applicable to the compensation of the unbalanced amount on the second side S2 of the rotor 1.

Refer to FIG. 3 and FIG. 6. The second image-capturing unit 37 can capture a third image of the second counterweight portions 15 located on the third terminal surface E3. The offset angle calculation unit 38 can obtain the third orientation of the second designated counterweight portion corresponding to the second counterweight portions 15 according to the third image. In an embodiment, the second image-capturing unit 37 can move along the axial direction A1 to capture the image of the positioning structure 13 of the second side S2 of the rotor 1, then the offset angle calculation unit 38 can obtain the first orientation of the positioning structure 13 according to the image. In another embodiment, the second image-capturing unit 37 does not have to capture the image of the positioning structure 13 on the second side S2 of the rotor 1, and the offset angle calculation unit 38 can directly obtain the first orientation of the positioning structure 13 according to the first image captured by the first image-capturing unit 35. The offset angle calculation unit 38 can obtain a second angular difference between the first orientation and the third orientation. The method of obtaining the second angular difference is similar to the method of obtaining the first angular difference, and the similarities are not repeated here.

Similar to the method of obtaining the first compensation angle and the first compensation mass, the dynamic balance test processing unit 32 can receive the second compensation angle on the second side S2 of the rotor 1 and the second compensation mass corresponding to the second compensation angle, the second compensation angle is generated by using the positioning structure 13 as the datum point of the dynamic balance polar coordinate system.

Similar to the method of obtaining at least one second actual compensation position and at least one second actual compensation mass, the compensation calculation unit 39 can generate at least one second actual compensation position and at least one second actual compensation mass corresponding to the at least one second actual compensation position according to the second angular difference, the second compensation angle and the second compensation mass.

Besides, the sequence of steps S11 to S19 illustrated in FIG. 7 can be adjusted according to actual situations. For instance, in step S16 of performing a dynamic balance test, the positioning structure 13 of the rotor 1 is positioned at the position of the original point (referring to step S165 of FIG. 9), the position of the original point will be consistent with the datum point P_{d} of the dynamic balance polar coordinate system C_{d} (referring to FIG. 11A, FIG. 12A and FIG. 13A). Thus, in step S14 of obtaining the first orientation θ1 of the positioning structure 13, as the positioning structure 13 of the rotor 1 will be positioned at the position of the original point when the dynamic balance test is performed, the first orientation θ1 of the positioning structure 13 can be directly obtained. That is, since steps S13 to S15 can be performed after step S16, the first orientation θ1 will be consistent with the datum point P_{d} of the dynamic balance polar coordinate system C_{d}.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A dynamic balance inspection system for performing dynamic balance inspection on a dynamic balancer with respect to a rotor of a motor, wherein the rotor comprises a positioning structure and a plurality of first counterweight portions located on a first side of the rotor, and the dynamic balance inspection system comprises:
a first image-capturing unit disposed on the first side of the rotor and movable along an axial direction to capture a first image of a positioning structure located on a first terminal surface and a second image of the first counterweight portions located on a second terminal surface, wherein the first terminal surface and the second terminal surface are perpendicular to the axial direction and are spaced from each other in the axial direction;
an offset angle calculation unit electrically connected to the first image-capturing unit to obtain a first orientation corresponding to the positioning structure according to the first image, obtain a second orientation corresponding to a first designated counterweight portion of the first counterweight portions according to the second image, and obtain a first angular difference between the first orientation and the second orientation;
a dynamic balance test processing unit electrically connected to the dynamic balancer to receive a first compensation angle of the first side of the rotor and a first compensation mass corresponding to the first compensation angle from the dynamic balancer, wherein the first compensation angle is generated by using the positioning structure as a datum point of a dynamic balance polar coordinate system; and
a compensation calculation unit electrically connected to the offset angle calculation unit and the dynamic balance test processing unit to generate at least one first actual compensation position and at least one first actual compensation mass corresponding to the at least one first actual compensation position according to the first angular difference, the first compensation angle and the first compensation mass.

2. The dynamic balance inspection system according to claim 1, wherein the compensation calculation unit generates a first corrected compensation angle by correcting the first compensation angle according to the first angular difference, locates at least one first target counterweight portion as the at least one first actual compensation position from the first counterweight portions according to the first corrected compensation angle, and allocates the at least one first actual compensation mass to the at least one first actual compensation position according to the first compensation mass and the at least one first actual compensation position; the first corrected compensation angle is generated by using the first designated counterweight portion as a datum point of a first compensation polar coordinate system.

3. The dynamic balance inspection system according to claim 2, wherein the compensation calculation unit locates at least one portion closest to the first corrected compensation angle as the at least one first target counterweight portion from the first counterweight portions.

4. The dynamic balance inspection system according to claim 2, wherein the compensation calculation unit locates the at least one first actual compensation position and allocates the at least one first actual compensation mass to the at least one first actual compensation position by means of optimization.

5. The dynamic balance inspection system according to claim 1, further comprising:
a display unit electrically connected to the compensation calculation unit to display a first compensation suggested image, wherein the first compensation suggested image is obtained by marking the at least one first actual compensation position and the at least one first actual compensation mass on a first side image corresponding to the first side of the rotor.

6. The dynamic balance inspection system according to claim 1, wherein the rotor comprises a shaft rotating along the axial direction, and the positioning structure is located on the shaft.

7. The dynamic balance inspection system according to claim 1, wherein the rotor further comprises a plurality of second counterweight portions located on the second side of the rotor, and the dynamic balance inspection system further comprises:
a second image-capturing unit disposed on the second side of the rotor to capture a third image of the second counterweight portions located on a third terminal surface, wherein the third terminal surface is perpendicular to the axial direction and is separated apart from the first terminal surface and the second terminal surface in the axial direction;
wherein, the offset angle calculation unit is electrically connected to the second image-capturing unit to obtain a third orientation corresponding to a second designated counterweight portion of the second counterweight portions according to the third image and obtain a second angular difference between the first orientation and the third orientation;
the dynamic balance test processing unit is used to receive a second compensation angle of the second side of the rotor and a second compensation mass corresponding to the second compensation angle, wherein the second compensation angle is generated by using the positioning structure as the datum point of the dynamic balance polar coordinate system;
the compensation calculation unit is used to generate at least one second actual compensation position and at least one second actual compensation mass corresponding to the at least one second actual compensation position according to the second angular difference, the second compensation angle and the second compensation mass.

8. The dynamic balance inspection system according to claim 1, wherein the first orientation is consistent with the datum point of the dynamic balance polar coordinate system.

9. The dynamic balance inspection system according to claim 1, wherein the at least one first actual compensation mass has a fixed mass.

10. The dynamic balance inspection system according to claim 1, further comprising:
a storage unit electrically connected to the dynamic balance test processing unit to store a plurality of adjustment information corresponding to different rotors;
wherein the dynamic balance test processing unit is used to adjust at least one of span and level of the supporting structure of the dynamic balancer and height of a carrier carrying the rotor according to the plurality of adjustment information of the rotor.

11. The dynamic balance inspection system according to claim 10, further comprising:
a first movement mechanism used to drive the first image-capturing unit to move along the axial direction; and
a movement control portion electrically connected to the storage unit to enable the first movement mechanism to adjust a shooting position at which the first image-capturing unit captures the first image and the second image according to the plurality of adjustment information of the rotor.

12. The dynamic balance inspection system according to claim 1, wherein the dynamic balance inspection system further comprises an offset position calculation unit, which calculates an inner circle diameter and a center position of the shaft of the rotor according to the first image and calculates an outer circle diameter and a center position of the body of the rotor according to the second image to determine whether the shaft in and the body is located at a normal position.

13. A dynamic balance inspection method for performing dynamic balance inspection on a dynamic balancer with respect to a rotor of a motor, wherein the rotor comprises a positioning structure and a plurality of first counterweight portions located on a first side of the rotor, the dynamic balance inspection method comprising:
capturing a first image of a positioning structure located on a first terminal surface and a second image of the first counterweight portions located on a second terminal surface by a first image-capturing unit, wherein the first image-capturing unit is disposed on the first side of the rotor and is movable along an axial direction, and the first terminal surface and the second terminal surface are perpendicular to the axial direction and are spaced from each other in the axial direction;
obtaining, by an offset angle calculation unit, a first orientation corresponding to the positioning structure according to the first image, obtaining a second orientation corresponding to a first designated counterweight portion of the first counterweight portions according to the second image, and obtaining a first angular difference between the first orientation and the second orientation;
receiving, by a dynamic balance test processing unit, a first compensation angle of the first side of the rotor and a first compensation mass corresponding to the first compensation angle from the dynamic balancer, wherein the first compensation angle is generated by using the positioning structure as a datum point of a dynamic balance polar coordinate system; and
generating, by a compensation calculation unit, at least one first actual compensation position and at least one first actual compensation mass corresponding to the at least one first actual compensation position according to the first angular difference, the first compensation angle and the first compensation mass.

14. The dynamic balance inspection method according to claim 13, wherein the step of generating the at least one first actual compensation position and the at least one first actual compensation mass comprises:
generating, by the compensation calculation unit, a first corrected compensation angle by correcting the first compensation angle according to the first angular difference;
locating, by the compensation calculation unit, at least one first target counterweight portion as the at least one first actual compensation position from the first counterweight portions according to the first corrected compensation angle; and
allocating, by the compensation calculation unit, the at least one first actual compensation mass to the at least one first actual compensation position according to the first compensation mass and the at least one first actual compensation position;
wherein the first corrected compensation angle is generated by using the first designated counterweight portion as a datum point of a first compensation polar coordinate system.

15. The dynamic balance inspection method according to claim 14, wherein in the step of locating the at least one first target counterweight portion as the at least one first actual compensation position, at least one portion closest to the first corrected compensation angle is selected as the at least one first target counterweight portion from the first counterweight portions.

16. The dynamic balance inspection method according to claim 14, wherein the at least one first actual compensation position is located, and the at least one first actual compensation mass is allocated to the at least one first actual compensation position by means of optimization.

17. The dynamic balance inspection method according to claim 13, further comprising:
displaying, by a display unit, a first compensation suggested image, wherein the first compensation suggested image is obtained by marking the at least one first actual compensation position and the at least one first actual compensation mass on a first side image of the first side corresponding to the rotor.

18. The dynamic balance inspection method according to claim 13, wherein the rotor further comprises a plurality of second counterweight portions located on a second side of the rotor, and the dynamic balance inspection method further comprises:
capturing a third image of the second counterweight portions located on a third terminal surface by a second image-capturing unit, wherein the second image-capturing unit is disposed on the second side of the rotor, and the third terminal surface is perpendicular to the axial direction and is separated apart from the first terminal surface and the second terminal surface in the axial direction;
obtaining, by the offset angle calculation unit, a third orientation corresponding to a second designated counterweight portion of the second counterweight portions according to the third image, and obtaining a second angular difference between the first orientation and the third orientation;
receiving, by the dynamic balance test processing unit, a second compensation angle of the second side of the rotor and a second compensation mass corresponding to the second compensation angle, wherein the second compensation angle is generated by using the positioning structure as the datum point of the dynamic balance polar coordinate system; and
generating, by the compensation calculation unit, at least one second actual compensation position and at least one second actual compensation mass corresponding to the at least one second actual compensation position according to the second angular difference, the second compensation angle and the second compensation mass.

19. The dynamic balance inspection method according to claim 13, wherein the first orientation is consistent with the datum point of the dynamic balance polar coordinate system.

20. The dynamic balance inspection method according to claim 13, further comprising:
storing a plurality of adjustment information corresponding to different rotors by a storage unit; and
adjusting, by a dynamic balance test processing unit, at least one of span and level of the supporting structure of the dynamic balancer and height of a carrier carrying the rotor according to the plurality of adjustment information of the rotor.

21. The dynamic balance inspection method according to claim 20, further comprising:
enabling, by a movement control portion, a first movement mechanism to adjust shooting position at which the first image-capturing unit captures the first image and the second image according to the plurality of adjustment information of the rotor.

22. The dynamic balance inspection method according to claim 13, wherein before the first angular difference is calculated, the method further comprises:
calculating, by an offset position calculation unit, an inner circle diameter and a center position of the shaft of the rotor according to the first image and calculating an outer circle diameter and a center position of the body of the rotor according to the second image to determine whether the shaft and the body are located at a normal position.
